(19) United States
(12) Patent Application Publication
(10) Pub. No.: US 2015/0135711 A1
(43) Pub. Date: May 21, 2015

(54) CIRCULATORY OSMOTIC PRESSURE ELECTRICITY GENERATION SYSTEM

(71) Applicant: Kabushiki Kaisha Toshiba, Minato-ku (JP)

(72) Inventors: Kenji SANO, Tokyo (JP); Toshihiro Imada, Kawasaki (JP)

(73) Assignee: Kabushiki Kaisha Toshiba, Minato-ku (JP)

(21) Appl. No.: 14/469,736

(22) Filed: Aug. 27, 2014

(30) Foreign Application Priority Data
Nov. 19, 2013 (JP) 2013-239335

(51) Int. Cl. F01K 25/06; F01K 7/16; B01D 61/00; F03G 6/00

(52) U.S. Cl. CPC F01K 25/06; F03G 6/003; F01K 7/16; B01D 61/002
USPC 60/641.8; 60/670

(57) ABSTRACT

According to one embodiment, a circulatory osmotic pressure electricity generation system configured to generate electricity by using a working medium, which includes an osmotic pressure generator, a turbine, a tank, a separating tower, a heat source and the working medium. The working medium has a critical temperature which separates a first temperature zone and a second temperature zone from each other and has a phase transition to a first phase or a second phase which occurs at the critical temperature. The osmotic pressure generator is placed under a temperature of the working medium within the first temperature zone, and comprises (i) a container, (ii) an osmosis membrane, (iii) a first inlet, (iv) a second inlet, and (v) an outlet.

### CROSS-REFERENCE TO RELATED APPLICATIONS

This application is based upon and claims the benefit of priority from prior Japanese Patent Application No. 2013-239335, filed Nov. 19, 2013, the entire contents of which are incorporated herein by reference.

### FIELD

Embodiments described herein relate generally to a circulatory osmotic pressure electricity generation system.

### BACKGROUND

When a solution having low concentration and another solution having high concentration are separated via an osmosis membrane, the solvent of the solution of low concentration permeate through the osmosis membrane to move to the side of the solution having high concentration. An osmotic pressure electricity generation apparatus which generates electricity by rotating the turbine by utilizing this solvent migration phenomenon has been proposed (See Japan National Publication No. 2010-509540).

There is another type of osmotic pressure electricity generation apparatus, which generates electricity by circulating a working medium within a closed system (closed loop). For example, Jeffrey R. McCutcheona et al., “A novel ammonia-carbon dioxide forward (direct) osmosis desalination process”, Desalination 174 (2005)1-11 and PCT Japan National Publication No. 2010-509540 disclose an electricity generation apparatus which uses an aqueous solution of ammonium carbonate as a working medium. In this apparatus, the turbine is rotated by water flow created by the difference in osmotic pressure between two types of aqueous solutions of ammonium carbonate having different concentrations from each other. The portions of the ammonium carbonate aqueous solutions used to rotate the turbine are heated for reuse and are separated into gas (carbon dioxide and ammonia) and an aqueous solution of ammonium carbonate having a very low concentration. The separated gaseous carbon dioxide and ammonia are reintroduced into water, thus obtaining an aqueous solution of ammonium carbonate having a very low concentration and an ammonium carbonate aqueous solution having a high concentration. Therefore, obtained two types of aqueous solutions of ammonium carbonate having different concentrations are re-circulated and used for electricity generation.

### BRIEF DESCRIPTION OF THE DRAWINGS

FIG. 1 is a block diagram showing an osmotic pressure generator according to the first embodiment;

FIG. 2 is a phase diagram of a working medium having a lower critical temperature;

FIG. 3 is a phase diagram of a working medium having a lower critical temperature;

FIG. 4 is a phase diagram of a working medium having a lower critical temperature;

FIG. 5 is a phase diagram of a working medium having a lower critical temperature;

FIG. 6 is a phase diagram of a working medium having a lower critical temperature;

FIG. 7 is a phase diagram of a working medium having a lower critical temperature;

FIG. 8 is a schematic diagram phase diagram of an osmotic pressure electricity generation system according to the first embodiment;

FIG. 9 is a cross-sectional view showing the osmotic pressure generator;

FIG. 10 is a block diagram showing an osmotic pressure generator according to the second embodiment;

FIG. 11 is a phase diagram of a working medium having an upper critical temperature;

FIG. 12 is a phase diagram of a working medium having an upper critical temperature;

FIG. 13 is a phase diagram of a working medium having an upper critical temperature;

FIG. 14 is a phase diagram of a working medium having an upper critical temperature;

FIG. 15A is a schematic diagram of an osmotic pressure electricity generation system according to the second embodiment;

FIG. 15B is a schematic diagram of another version of the osmotic pressure electricity generation system according to the second embodiment;

FIG. 16 is a diagram showing an osmotic pressure electricity generation system according to the third embodiment;

FIG. 17 is a diagram showing an example of the osmotic pressure generator;

FIG. 18 is a schematic diagram phase diagram of an osmotic pressure electricity generation system according to the fourth embodiment;

FIG. 19A is a schematic diagram phase diagram of an osmotic pressure electricity generation system according to the fifth embodiment;

FIG. 19B is a schematic diagram phase diagram of another version of the osmotic pressure electricity generation system according to the fifth embodiment;

FIG. 20A is a schematic diagram phase diagram of an osmotic pressure electricity generation system according to the sixth embodiment;

FIG. 20B is a schematic diagram phase diagram of another version of the osmotic pressure electricity generation system according to the sixth embodiment;

FIG. 21 is a diagram showing a syringe test device;

FIG. 22 is a graph showing results of a syringe test; and

FIG. 23 is a diagram showing a syringe test device.

### DETAILED DESCRIPTION

In general, according to a first embodiment, a circulatory osmotic pressure electricity generation system configured to generate electricity by using a working medium is provided, which comprises an osmotic pressure generator, a turbine, a tank, a separating tower, a heat source and the working medium. The working medium has a critical temperature which separates a first temperature zone and a second temperature zone from each other and has a phase transition to a first phase or a second phase which occurs at the critical temperature: a) in the first temperature zone, a first liquid and a second liquid are dissolved in a liquid-liquid mutual dissolution state to form a two-component mixed solution; and b) in the second temperature zone, the first liquid and the second liquid are in a phase separation state. The osmotic pressure generator is placed under a temperature of the working medium within the first temperature zone, and comprises: (i) a container; (ii) an osmosis membrane configured to compartmentalize an inside of the container into a first chamber and a second chamber; (iii) a first inlet provided in a section of the container which is located the first chamber, and configured to allow the first liquid to flow therein; (iv) a second inlet provided in a section of the container which is located the second chamber, and configured to allow the second liquid to flow therein; and (v) an outlet provided in a section of the container which is located the second chamber, and configured to allow the two-component mixed solution to flow out there through, the two-component mixed solution being obtained from the second liquid and a portion of the first liquid dissolving each other in a liquid-liquid mutual dissolution manner in the second chamber, the portion of the first liquid being liquid which permeates through the osmosis membrane from the first chamber to the second chamber. The turbine is configured to generate electricity by flow of the two-component mixed solution flowing out through the outlet from the second chamber of the osmotic pressure generator. The tank is configured to accommodate the two-component mixed solution used to drive the turbine. The heat source is mounted one of the separating tower and the osmotic pressure generator, and configured to heat liquid contained in the separating tower or the osmotic pressure generator to a temperature higher than the critical temperature. The separating tower is configured to separate the two-component mixed solution flowing out from the tank at a temperature in the second temperature zone into the first liquid to be returned to the first chamber and the second liquid to be returned to the second chamber.

Various embodiments will now be explained with reference to accompanying drawings. Common structural elements throughout the embodiments will be designated by the same reference symbols, and the explanations therefore will not be repeated. Further, each drawing is a schematic diagram to assist readers to easily understand each version thereof, and thus the shapes, dimensions, ratios, etc. illustrated may be different from those of the actual apparatus and may be changed in designing as needed with reference to the following explanations and publicly known techniques.

A circulatory osmotic pressure electricity generation system according to one embodiment generates electricity by using a working medium having a critical temperature. The critical temperature may be an upper or lower critical temperature. The working medium having a critical temperature means a working medium having an upper critical temperature or a lower critical temperature, or a working medium having both an upper critical temperature and a lower critical temperature.

Such a working medium having a critical temperature(s) comprises two liquid components, that is, a first liquid and a second liquid, and has a phase transition to a first phase or a second phase which occurs at the critical temperature. The first and the second phases are divided into a first temperature zone and a second temperature zone, respectively. The first phase of the working medium is a state of a two-component mixed solution in which the first and second liquids are liquid-liquid mutually dissolved with each other. The second phase of the working medium is a phase separation state in which the two-component mixed solution is separated into the first and second liquids.

The working medium having a lower critical temperature and the working medium having an upper critical temperature described above will now be described in detail.

The working medium having a lower critical temperature takes, when the temperature of the working medium is decreased to a temperature lower than the lower critical temperature, a state of a two-component mixed solution, that is, the first phase, in which the first and second liquids are liquid-liquid mutually dissolved with each other. The first phase comprises a homogeneous single phase liquid. Meanwhile, when the temperature of the working medium is increased to a temperature higher than the lower critical temperature, the medium takes a phase separation state, that is, the second phase, in which the two-component mixed solution is separated into the first and second liquids.

On the other hand, the working medium having an upper critical temperature takes, when the temperature of the working medium is increased to a temperature higher than the lower critical temperature, a state of a two-component mixed solution, that is, the first phase, in which the first and second liquids are liquid-liquid mutually dissolved with each other. In the case of the working medium having an upper critical temperature as well, the first phase comprises a homogeneous single phase liquid. Meanwhile, when the temperature of the working medium is decreased to a temperature lower than the lower critical temperature, the medium takes a phase separation state, that is, the second phase, in which the two-component mixed solution is separated into the first and second liquids.

Embodiments described here provides a circulatory osmotic pressure electricity generation system configured to generate electricity by using a working medium exhibiting such a phase transition, and also a working medium exhibiting such a phase transition.

### First Embodiment

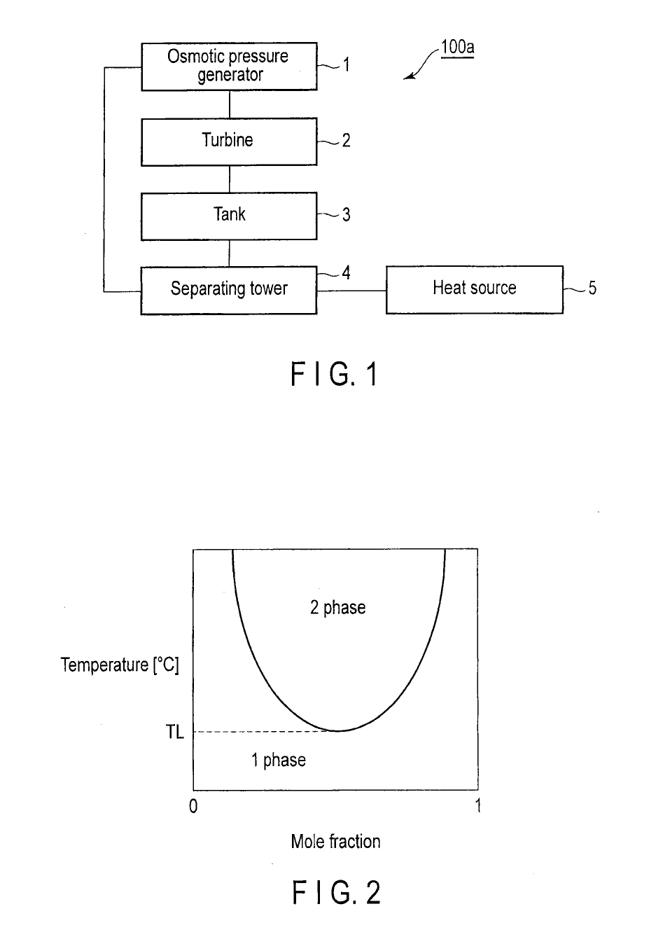

A circulatory osmotic pressure electricity generation system of this embodiment comprises an osmotic pressure electricity generating apparatus and a working medium having a lower critical temperature. FIG. 1 is a block diagram showing the osmotic pressure electricity generating apparatus. The osmotic pressure electricity generating apparatus 100a comprises an osmotic pressure generator 1, a turbine 2, a tank 3, a separating tower 4 and a heat source 5. The osmotic pressure generator 1, the turbine 2, the tank 3 and the separating tower 4 are connected one another in this order, and the separating tower 4 is connected to the osmotic pressure generator 1, thus forming a loop as a whole. The heat source 5 is attached to the separating tower 4. A working medium circulates though the loop comprising the osmotic pressure generator 1, the turbine 2, the tank 3 and the separating tower 4.

The working medium having a lower critical temperature is subjected to a phase transition of two states depending on temperature as previously mentioned. More specifically, at a temperature lower than the lower critical temperature, the working medium is in a state of a mixture of two-component liquids dissolved with each other. At a temperature higher than the lower critical temperature, the working medium is in a phase separation state of two liquids. Thus, this working medium takes a phase separation state of a low-concentration solution and a high-concentration solution when heated to a temperature higher than the lower critical temperature, whereas it takes a single-phase two-component mixed solution in which the two liquids are liquid-liquid mutually dissolved with each other when cooled down to a temperature lower than the lower critical temperature. Here, the expressions “low” and “high” which modify the relative degree of concentration with reference to that of a single component of the same kind. When a low-concentration solution and a high-concentration solution obtained by phase separation are brought into contact with each other via an osmosis membrane, the solvent of the low-concentration solution moves to the side of the high-concentration solution, thereby creating water flow.

In the circulatory osmotic pressure electricity generation system, the osmotic pressure generator 1 accommodates the low-concentration solution and the high-concentration solution while these solutions are separated via the osmosis membrane. In this state, an osmotic pressure difference is created between the low-concentration solution and the high-concentration solution, thus creating water flow which rotates the turbine 2. Here, when the osmotic pressure generator 1 is placed at a temperature lower than the lower critical temperature, a state of a single-phase two-component mixed solution is created a state in which a portion of the solvent of the low-concentration solution and the high-concentration solution are liquid-liquid mutually dissolved with each other. Therefore, the water flow becomes a flux of the single-phase two-component mixed solution. The water flow created in the osmotic pressure generator 1 is transferred to the turbine 2. The turbine 2 is rotated by the pressure of the water flow transferred thereto, thereby generating electricity.

After rotating the turbine 2 for electricity generation, the two-component mixed solution is transferred to the separating tower 4. In the separating tower 4, the two-component mixed solution is heated, and is subjected to phase separation back into a low-concentration solution and a high-concentration solution as mentioned previously. While the two-component mixed solution is being subjected to separation in the separating tower 4, the two-component mixed solution continuously flowing thereto is reserved in the tank 3. After the phase separation of the two-component mixed solution into two liquids in the separating tower 4, the separated liquids, that is, a low-concentration solution and a high-concentration solution, are each re-circulated to the osmotic pressure generator 1.

According to the circulatory osmotic pressure electricity generation system of the first embodiment described above, the working medium is circulated and thus the heat energy for the phase separation can be converted to electrical energy obtained by rotating the turbine 2.

In the first embodiment, the working medium has a lower critical solution temperature (LCST). That is, when the working medium is cooled to a temperature lower than the lower critical temperature TL, the low-concentration solution and the high-concentration solution separated into two phases are homogeneously dissolved with each other to make a single-phase mixed solution. On the other hand, when the working medium is heated to a temperature higher than the lower critical temperature TL, the working medium of the single-phase homogeneous mixed solution separates into a low-concentration solution and a high-concentration solution to make a two-phase liquid. In other words, when the working medium is heated to a temperature higher than the lower critical temperature TL, the phase transition occurs from the liquid-liquid mutually dissolved single-phase two-component mixed solution to a state of phase separation of a low-concentration solution and a high-concentration solution.

FIG. 2 is a phase diagram of a two-liquid mixed solution having the lower critical temperature TL. In the temperature zone located above the lower critical temperature curve, the two-liquid mixed solution is in a state of separation into two phases. In the temperature zone located below the lower critical temperature curve, the two-liquid mixed solution is homogeneously mixed.

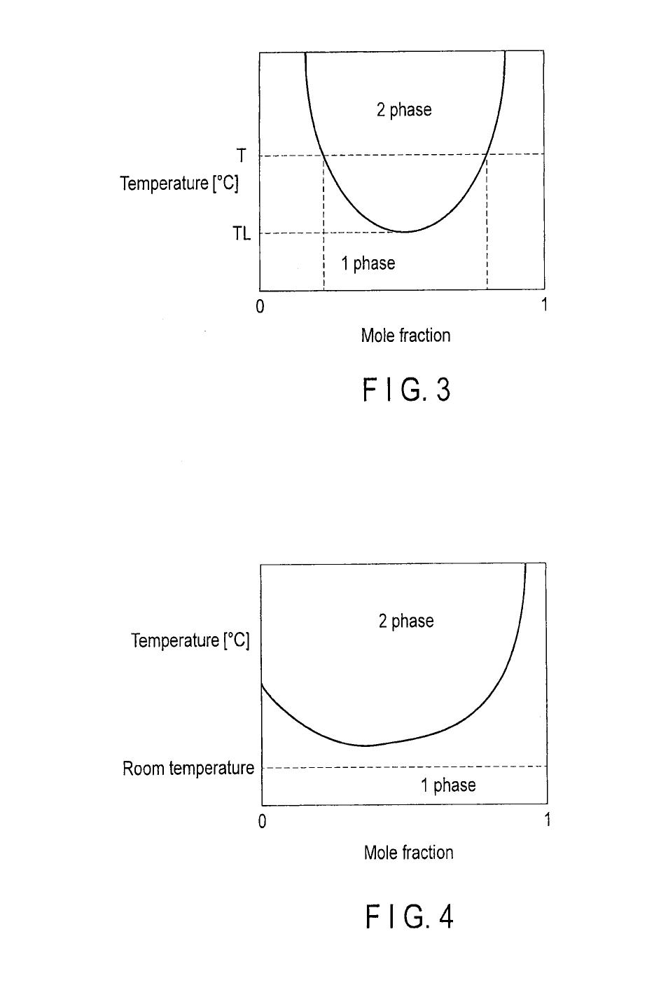

FIG. 3 is a diagram indicating by mole fraction the concentration of each of the low-concentration solution and high-concentration solution created when heating the working medium having the lower critical temperature TL to a temperature T higher than the lower critical temperature. The ratio in amount of the low-concentration solution to the high-concentration solution obtained by separation is determined according to Lever rule.

FIG. 4 is a diagram indicating an ideal phase of the working medium having a lower critical temperature. As shown in FIG. 4, it is preferable in the working medium that the border line between the single-phase region and the two-phase region should have an intersect point with the vertical axis on a left side. Here, the single-phase region is a region in the phase diagram, where the working medium can retain itself in the state of a liquid-liquid mutually dissolved single-phase mixed solution. On the other hand, the two-phase region is a region in the phase diagram, where the working medium is in the state of phase separation of two phases of liquids. In this case, one of the two liquids separated becomes a pure solvent, and therefore the difference in concentration between the two liquids becomes large. Consequently, a large osmotic pressure is obtained between the two liquids. Meanwhile, it is preferable that the border line between the two-phase region and the single-phase region should be close to the right end, where the mole fraction is 1 in the phase diagram. In this case, the difference in temperature between the two liquids becomes large. Consequently, a large osmotic pressure is obtained between the two liquids. Further, it is preferable that the lower critical temperature should be higher than room temperature. In this case, even if the working medium is an aqueous solution, such a temperature region can be obtained that the working medium takes the state of a liquid-liquid mutually dissolved single-phase mixed solution without freezing. Therefore, in some cases, the term “low-concentration solution” may be replaced by, for example, “pure solvent” or “pure water”.

Examples of the working medium usable in the first embodiment are an aqueous solution of diethylamine, an aqueous solution of nicotine, an aqueous solution of 2-butoxyethanol, an aqueous solution of 2-methylpiperidine and an aqueous solution of 4-methylpiperidine. Table 1 indicates the lower critical temperatures of the aqueous solutions.

TABLE 1

| | | Lower critical |
|---|---|---|
| Solvent 1 | Solvent 2 | temperature (° C.) |
| Water | Diethylamine | 143.5 |
| Water | Nicotine | 60.8 |
| Water | 2-butoxyethanol | 49 |
| Water | 2-methylpiperidine | 69.7 |
| Water | 4-methylpiperidine | 84.5 |

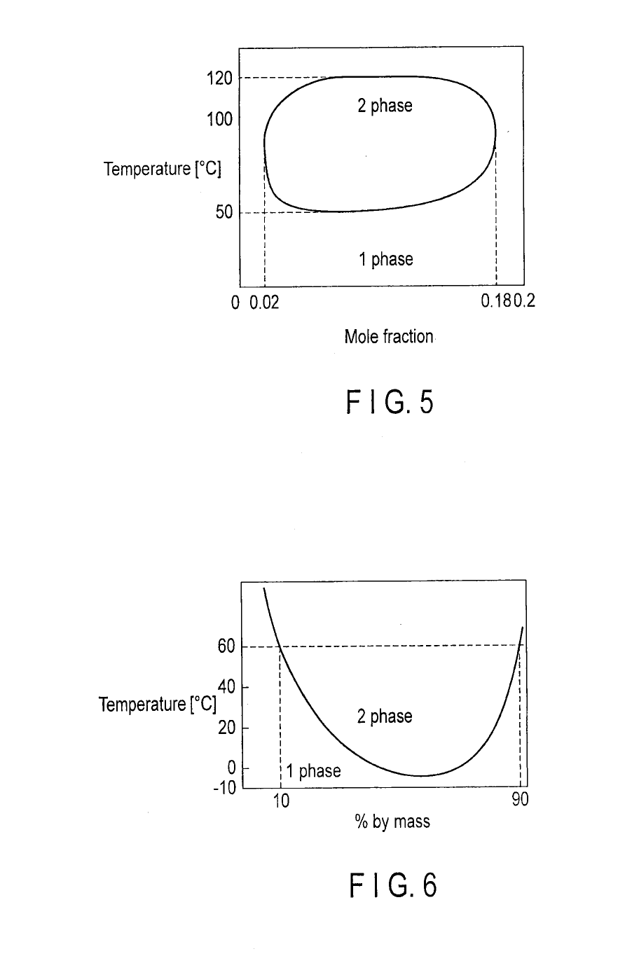

FIGS. 5 to 7 are phase diagrams of the aqueous solutions listed in Table 1.

FIG. 5 is a phase diagram of the aqueous solution of 2-butoxyethanol having a mole fraction of 0.1.

The aqueous solution of 2-butoxyethanol with this concentration has a lower critical temperature of about 60° C. and an upper critical temperature of about 120° C. In this case, when the aqueous solution is heated to, for example, 75° C., the phase separation occurs to have an aqueous solution of 2-butoxyethanol having a mole fraction of about 0.02 and an aqueous solution of 2-butoxyethanol having a mole fraction of about 0.18. The difference in osmotic pressure between the separated two liquids is about 70 atm. This value is about 2.4 times as high as the osmotic pressure difference between sea water having a salt concentration of about 3.5% by mass and river water having a salt concentration of about 0% by mass.

FIG. 6 is a phase diagram of an aqueous solution of dipropylamine having a concentration of 40% by mass. The aqueous solution of dipropylamine with this concentration has a lower critical temperature. As shown in FIG. 6, when this aqueous solution is heated to 60° C., the phase separation occurs to have an aqueous solution of dipropylamine having a concentration of about 2% by mass and an aqueous solution of dipropylamine having a concentration of about 90% by mass. The difference in osmotic pressure between the separated two liquids is about 228 atmospheres. This value is about 7.9 times as high as the osmotic pressure difference between sea water having a salt concentration of about 3.5% by mass and river water having a salt concentration of about 0% by mass.

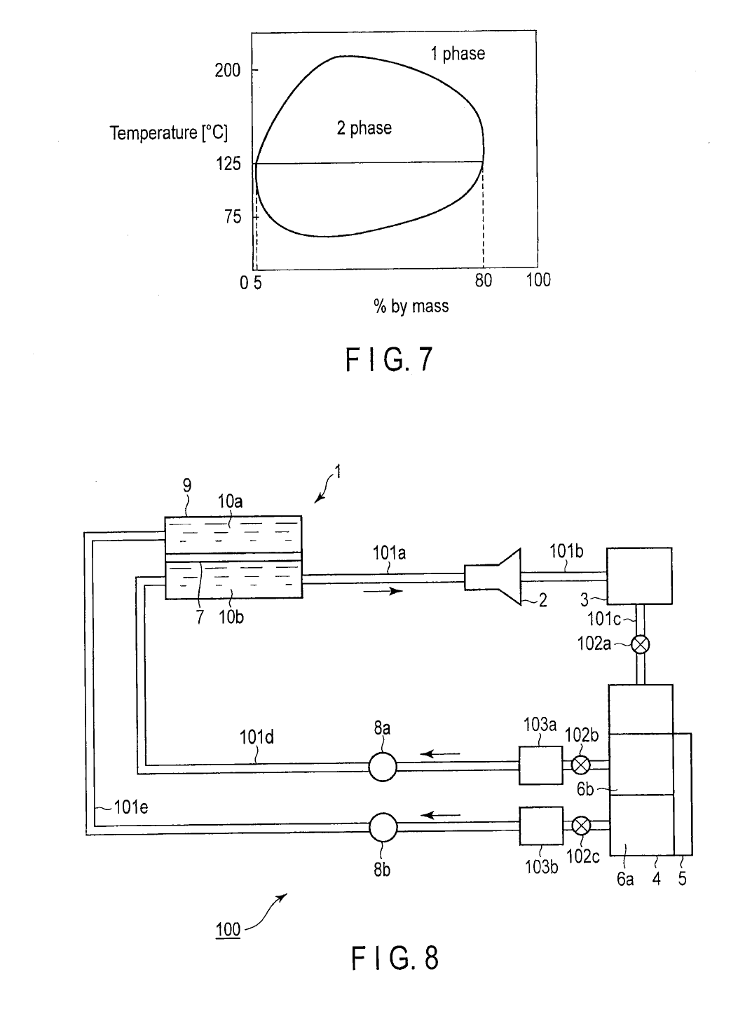

FIG. 7 is a phase diagram of an aqueous solution of nicotine having a concentration of 40% by mass. The nicotine aqueous solution with this concentration has a lower critical temperature and an upper critical temperature. As shown in FIG. 7, when this aqueous solution is heated to 120° C., the phase separation occurs to have an aqueous solution of nicotine having a concentration of about 5% by mass and an aqueous solution of nicotine having a concentration of about 80% by mass. The difference in osmotic pressure between the separated two liquids is about 113 atmospheres. This value is about 4 times as high as the osmotic pressure difference between sea water having a salt concentration of about 3.5% by mass and river water having a salt concentration of about 0% by mass.

FIG. 8 is a schematic diagram showing one example of the circulatory osmotic pressure electricity generation system of the first embodiment. The circulatory osmotic pressure electricity generation system will now be described with reference to FIG. 8.

A circulatory osmotic pressure electricity generation system 100 comprises an osmotic pressure electricity generating apparatus 100a and a working medium circulating in the osmotic pressure electricity generating apparatus 100a. The osmotic pressure electricity generating apparatus 100a comprises an osmotic pressure generator 1, a turbine 2, a buffer tank 3, a separating tower 4 and a heat source 5. The osmotic pressure generator 1 and the turbine 2 are connected to each other via a pipeline 101a. The turbine 2 and the tank 3 are connected to each other via a pipeline 101b. The tank 3 and the separating tower 4 are connected to each other via a pipeline 101c. An on-off valve 102a is interposed in pipeline 101c. The separating tower 4 and the osmotic pressure generator 1 are connected to each other via a pipeline 101d and a pipeline 101e. An on-off valve 102b, a tank 103a and a pump 8a are interposed in pipeline 101d in this order from the side of the separating tower 4. An on-off valve 102c, a tank 103b and a pump 8b are interposed in the pipeline 101e in this order from the side of the separating tower 4. The heat source 5 is mounted on the separating tower 4.

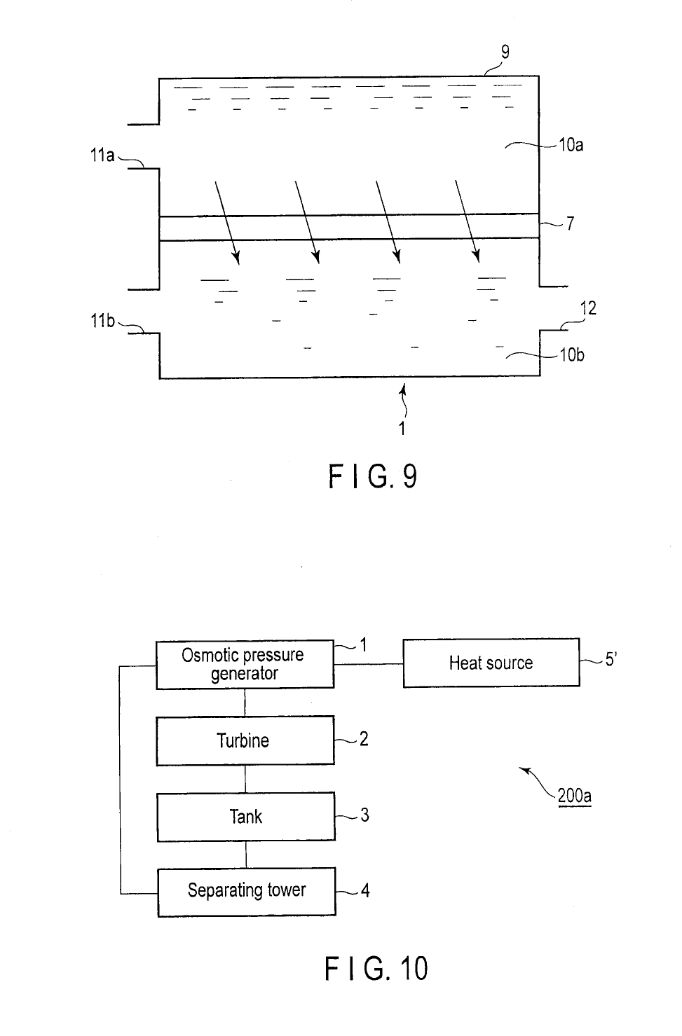

The internal structure of the osmotic pressure generator 1 will now be described with reference to the cross-sectional diagram of FIG. 9.

The osmotic pressure generator 1 comprises a sealed container 9 and an osmosis membrane 7. The osmosis membrane 7 is placed in the sealed container 9 while the periphery of the membrane being fixed onto inner wall surfaces of the sealed container 9. Thus, the membrane 7 divides the inside of the sealed container 9 into, for example, an upper compartment and a lower compartment, namely, a first chamber 10a and a second chamber 10b. A side wall of the container 9, which is situated the first chamber 10a, has an opening of a first inlet 11a. Through the first inlet 11a, a low-concentration solution 6a separated by heating the working medium is allowed to flow in. A side wall of the container 9, which is situated the second chamber, has an opening of a second inlet 11b. Through the second inlet 11b, a high-concentration solution 6b separated by heating the working medium is allowed to flow in. The osmotic pressure generator 1 is placed in such an environment that the temperature of the low-concentration solution 6a and that of the high-concentration solution 6b, flowing into the second inlets 11a and 11b are both lower than the lower critical temperature. That is, the low-concentration solution 6a and the high-concentration solution 6b are placed in such a temperature environment that the solutions are liquid-liquid mutually dissolved with each other to make a single-phase mixed solution. At such a temperature, the low-concentration solution 6a flows into the first chamber 10a and the high-concentration solution 6b flows into the second chamber 10b. During this period, a portion of the low-concentration solution 6a, which is already in the first chamber 10a permeates the osmosis membrane by the osmotic pressure difference, to move from the first chamber 10a to the second chamber 10b. In FIG. 9, the flow of the liquid is indicated by an arrow.

A side wall of the container 9, which is situated the second chamber 10b, has an opening of an outlet 12. The outlet 12 is communicated to the turbine 2 via a pipe 101a. The portion of the low-concentration solution 6a, which permeates the osmosis membrane 7 and moves from the first chamber 10a to the second chamber 10b, and the high-concentration solution 6b are mixed together to make a liquid-liquid mutually dissolved mixed solution, which flows out from the outlet 12 towards the turbine 2. That is, as the portion of the low-concentration solution 6a permeates the osmosis membrane 7 and moves from the first chamber 10a to the second chamber 10b, the water pressure in the second chamber 10b increases, thus creating a flux (liquid flow) from the outlet 12. The flux rotates the turbine 2 and thus electricity is generated.

As shown in FIG. 8, the osmotic pressure generator 1 used in the first embodiment employs a cross-flow mode, in which the liquid is allowed to continuously flow along the surface of the osmosis membrane V. With the cross-flow mode, the drawback of concentration polarization, in which a portion of the low-concentration solution 6a remains near the osmosis membrane 7 after migrating from the first chamber 10a to the second chamber 10b, thereby decreasing the difference in osmotic pressure, can be suppressed.

The first embodiment is described in connection with the sealed container 9 of a vertical type in which the first and second chambers 10a and 10b are arranged in a vertical direction. But the sealed container 9 is not limited to the vertical type, but it may as well be a horizontal type in which the first chamber 10a and the second chamber 10b are arranged in a horizontal direction to the surface on which they are placed. Further, it is alternatively possible that the sealed container 9 is formed such that the first chamber 10a and the second chamber 10b are disposed side by side while interposing the osmosis membrane 7 therebetween and at different levels with respect to the surface on which they are placed.

The first embodiment is described with an exemplified case where the sealed container 9 is of a hollow box shape. The shape is not limited to a box-type, but may be, for example, a hollow cylinder, cone, prism or pyramid.

The osmosis membrane 7 used in the osmotic pressure generator 1 may be any commercially available type as long as it is not damaged by a liquid used as the working medium, for example, an organic solvent. Usable examples of the osmosis membrane 7 are a cellulose acetate film and a polyamide film. The osmosis membrane 7 may be, for example, a forward osmosis membrane or a reverse osmosis membrane, though the forward osmosis membrane is preferable.

The sealed container 9 should only be formed of a material suitable to accommodate the working medium.

The two-component mixed solution flowing out of the second outlet 12 is transferred through pipeline 101a to the turbine 2. (See FIG. 2.) The flux created by the two-component mixed solution transferred rotates the turbine 2, thereby generating electricity.

After generating electricity by rotating the turbine 2, the two-component mixed solution is transferred to the tank 3 via pipeline 101b. The tank 3 temporarily accommodates the two-component mixed solution. The tank 3 is connected to the separating tower 4 via pipeline 101c. The on-off valve 102a is interposed in pipeline 101c. The on-off valve 102a is closed while the phase separation of the working medium is in progress in the separating tower 4 and also the liquid are transferred. The on-off valve 102a is opened to allow the two-component mixed solution to flow into the separating tower 4.

The separating tower 4 comprises an inlet through which the two-component mixed solution flowing out of the tank 3 is allowed to come in, and two outlets through which liquids separated into two phases are allowed to flow out, respectively. While the two-component mixed solution is subjected to phase separation in the separating tower 4, the on-off valve 102a is closed to inhibit the liquid from flowing into the separating tower 4. In this way, the phase separation is promoted. In the separating tower 4, the two-component mixed solution flowing thereinto is heated to a temperature higher than the lower critical temperature of the working medium with the heat of the heat source 5. Thus, the two-component mixed solution is separated into two-phase liquids by phase separation. The separation by heat should be carried out in such a temperature range that the working medium does not lose its function as a liquid. For example, the working medium should be heated within such a temperature range that the working medium does not excessively gasifies in the separating tower 4. As the heat source 5, any conventionally known type may be used, for example, water heated with exhaust heat of a factory, geothermal or solar energy.

After the separation of the two-component mixed solution is finished in the separating tower 4, the liquids of two phases obtained by the phase separation are allowed to flow out from the separating tower 4. Subsequently, the on-off valve is opened to allow the two-component mixed solution accommodated in the tank 3 to flow once again into the separating tower 4. When a sufficient amount of the two-component mixed solution flows into the separating tower 4, the on-off valve is closed. In the separating tower 4, the above-described separating operation is repeated.

The two liquids flowing out from the separating tower 4 are returned to the first chamber 10a and the second chamber 10b of the container 9 using pumps 8a and 8b, respectively.

As the working medium circulates in the osmotic pressure electricity generating apparatus 100a, the circulatory osmotic pressure electricity generation system continuously generates electricity. The working medium should only be selected from those having a lower critical temperature appropriate for the environment in which the osmotic pressure electricity generation system is operated. It is preferable that the osmotic pressure electricity generation system should be placed in an environment cooler than the lower critical temperature of the working medium employed. In this manner, the temperature can be controlled only by the heat of the heat source 5 mounted on the separating tower 4. For example, it is preferable that such a working medium whose lower critical temperature is in a zone lower than room temperature at all times be selected. The members other than the separating tower 4 are placed at a temperature lower than the lower critical temperature. The temperature control in the osmotic pressure electricity generation system may be determined according to the lower critical temperature of the working medium employed.

As described above, the first embodiment employs the working medium separated into two liquids, and therefore the separating operation and the transfer and return of the liquids after separation are facilitated. Note that when an aqueous solution of ammonium carbonate or the like is employed as the working medium, the handling is difficult since the operation of separating the solution causes the generation of gas. On top of that, the separating operation itself is complicated.

Therefore, according to the first embodiment which employs a working medium separated into two liquids, the structure of the separating tower 4 can be simplified. Further, as compared to the case where a working medium which generates ammonia gas is employed, the osmotic pressure electricity generating apparatus 100a is not damaged by corrosive gas. Consequently, the maintenance cost of the apparatus can be decreased. Further, for example, exhaust heat can be utilized as the heat source 5, thus making it possible to perform clean electricity generation. Further, since the heat which is conventionally wasted can be utilized, the construction cost for installing the heat source and the running cost of the system can be reduced.

### Second Embodiment

A circulatory osmotic pressure electricity generation system of this embodiment comprises an osmotic pressure electricity generating apparatus and a working medium having an upper critical temperature. FIG. 10 is a block diagram showing the osmotic pressure electricity generating apparatus. The osmotic pressure electricity generating apparatus will now be described with reference to FIG. 10.

The osmotic pressure electricity generating apparatus 200a comprises an osmotic pressure generator 1, a turbine 2, a tank 3, a separating tower 4 and a heat source 5′. The osmotic pressure generator 1, the turbine 2, the tank 3 and the separating tower 4 are connected one another in this order, thus forming a loop. The heat source 5′ is attached to the osmotic pressure generator 1. A working medium circulates though the loop comprising the osmotic pressure generator 1, the turbine 2, the tank 3 and the separating tower 4.

The osmotic pressure electricity generating apparatus 200a of the second embodiment is similar to the osmotic pressure electricity generating apparatus 100a of the first embodiment except that the working medium has an upper critical temperature and the heat source 5′ is mounted not on the separating tower 4, but on the osmotic pressure generator 1.

The working medium having an upper critical temperature is a two-component liquid comprising two types of liquids as its components, and is subjected to phase transition of two states depending on temperature as previously mentioned. More specifically, at a temperature higher than the upper critical temperature, the working medium is in a state of mixture of two component liquids dissolved with each other. At a temperature lower than the upper critical temperature, the working medium is in a phase separation state of two liquids. Thus, this working medium takes a single-phase two-component mixed solution in which the two liquids are liquid-liquid mutually dissolved with each other when heated to a temperature higher than the upper critical temperature, whereas it takes a phase separation state of a high-concentration solution and a low-concentration solution when cooled to a temperature lower than the upper critical temperature. When a low-concentration solution and a high-concentration solution obtained by phase separation are brought into contact with each other via an osmosis membrane, the solvent of the low-concentration solution moves to the side of the high-concentration solution, thereby creating water flow.

In the circulatory osmotic pressure electricity generation system, the osmotic pressure generator 1 accommodates the low-concentration solution and the high-concentration solution while these solutions are separated via the osmosis membrane. In this state, an osmotic pressure difference is created between the low-concentration solution and the high-concentration solution, thus creating water flow which rotates the turbine 2. Here, when the osmotic pressure generator 1 is placed at a temperature higher than the upper critical temperature, a state of a single-phase two-component mixed solution is created in which a portion of the solvent of the low-concentration solution and the high-concentration solution are liquid-liquid mutually dissolved with each other. Therefore, the water flow becomes a flux of the single-phase two-component mixed solution. The water flow created in the osmotic pressure generator 1 is transferred to the turbine 2. The turbine 2 is rotated by the pressure of the water flow transferred thereto, thereby generating electricity.

After rotating the turbine 2 for electricity generation, the two-component mixed solution is let stand or cooled down in the separating tower 4, thus it is subjected to phase separation back into a low-concentration solution and a high-concentration solution. While the two-component mixed solution is subjected to separation in the separating tower 4, the two-component mixed solution continuously flowing thereto is reserved in the tank 3. After the phase separation of the two-component mixed solution into two liquids in the separating tower 4, the two separated liquids, that is, a low-concentration solution and a high-concentration solution are each re-circulated to the osmotic pressure generator 1.

According to the circulatory osmotic pressure electricity generation system of the second embodiment described above, the working medium is circulated and thus the heat energy for the phase separation can be converted to electrical energy obtained by rotating the turbine 2.

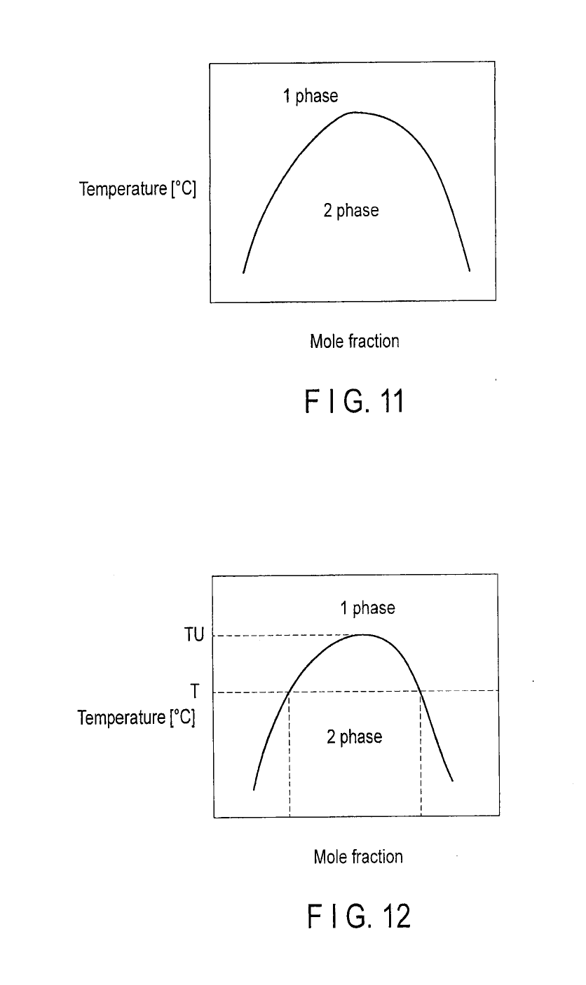

In the second embodiment, the working medium has an upper critical temperature TU. That is, when the working medium is heated to a temperature higher than the upper critical temperature TU, the low-concentration solution and the high-concentration solution separated into two phases are homogeneously dissolved with each other to make a single-phase mixed solution. On the other hand, when the working medium is cooled down to a temperature lower than the upper critical temperature TU, the working medium of the single-phase homogeneous mixed solution separates into a low-concentration solution and a high-concentration solution to make a two-phase liquid. In other words, when the working medium is cooled to a temperature lower than the upper critical temperature TU, the phase transition occurs from the liquid-liquid mutually dissolved single-phase two-component mixed solution to a state of phase separation of a low-concentration solution and a high-concentration solution. FIG. 11 is a phase diagram of a two-liquid mixed solution having the upper critical temperature TU. In the temperature zone located below the upper critical temperature curve, the two-liquid mixed solution is in a state of separation into two phases. In the temperature zone located above the upper critical temperature curve, the two-liquid mixed solution is homogeneously mixed.

FIG. 12 is a diagram indicating by mole fraction the concentration of each of the low-concentration solution and high-concentration solution created when cooling the working medium having the upper critical temperature TU to a temperature T lower than the upper critical temperature. The ratio in amount between the low-concentration solution and high-concentration solution obtained by separation is determined according to a law similar to leverage.

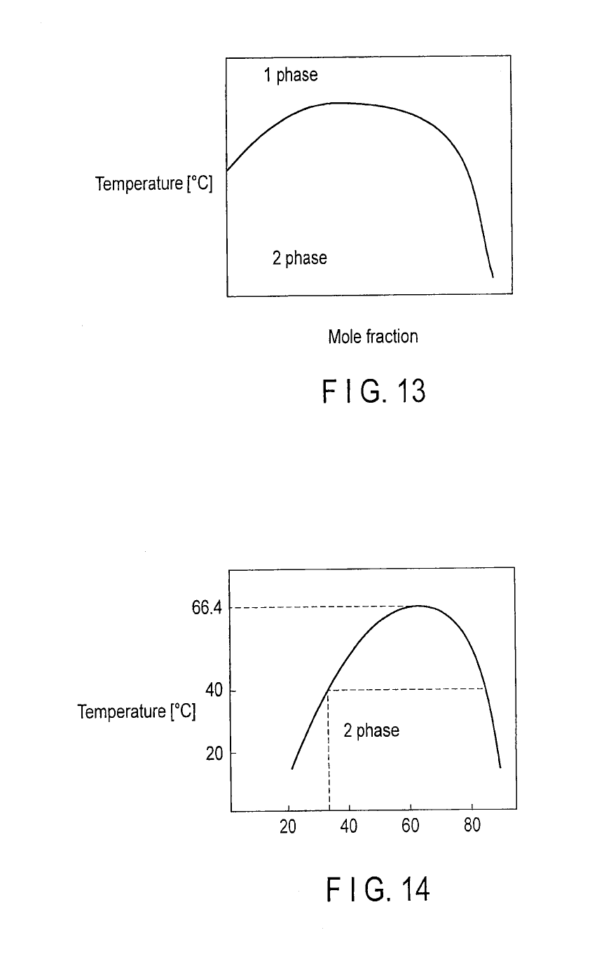

FIG. 13 is a diagram indicating an ideal phase of the working medium having an upper critical temperature. As shown in FIG. 13, it is preferable in the working medium that the border line between the single-phase region and the two-phase region should have an intersect point with the vertical axis on a left side. Here, the single-phase region is a region in the phase diagram, where the working medium can retain itself in the state of a liquid-liquid mutually dissolved single-phase mixed solution. On the other hand, the two-phase region is a region in the phase diagram, where the working medium is in the state of phase separation of two phases of liquids. In this case, one of the two liquids separated becomes a pure solvent, and therefore the difference in concentration between the two liquids becomes large. Consequently, a large osmotic pressure is obtained between the two liquids. Meanwhile, it is preferable that the border line between the two-phase region and the single-phase region should be close to the right end, where the mole fraction is 1 in the phase diagram. In this case, the difference in temperature between the two separated liquids becomes large. Consequently, a large osmotic pressure is obtained between the two liquids. Therefore, in some cases, the term “low-concentration solution” may be replaced by, for example, “pure solvent” or “pure water” having a concentration of 0%.

Examples of the working medium usable in the second embodiment are an aqueous solution of phenol, an aqueous solution of succinonitrile, an aqueous solution of nicotine, an aqueous solution of 2-butoxyethanol, an n-octane solution of phenol as its solvent, a glycerin solution of isoamyl alcohol as its solvent, a methylcyclohexane solution of methanol as its solvent, and a cyclohexane solution of methanol as its solvent. Table 2 indicates the upper critical temperatures of these solutions. Note that when an n-octane solution of phenol as its solvent, a glycerin solution of isoamyl alcohol as its solvent, a methylcyclohexane solution of methanol as its solvent, or a cyclohexane solution of methanol as its solvent is used as the working medium, the osmosis membrane should be selected from those transmissible for these organic solvents but not damaged by these as well.

TABLE 2

| | | Upper critical |
|---|---|---|
| Solvent 1 | Solvent 2 | temperature (° C.) |
| Water | Phenol | 66.4 |
| Water | Succinonitrile | 55.4 |
| Water | Nicotine | 206 |
| Water | 2-butoxyethanol | 129 |
| Phenol | n-octane | 57.5 |
| Isoamyl | Glycerin | 60.5 |
| alcohol | | |
| Methanol | Methylcyclohexane | 45 |
| Methanol | Cyclohexane | 55.8 |

FIG. 14 is a phase diagram of an aqueous solution of phenol having a concentration of 50% by mass. The aqueous solution of a phenol with this concentration has an upper critical temperature. As shown in FIG. 14, when this aqueous solution is cooled to 40° C., the phase separation occurs to have a phenol aqueous solution having a concentration of about 10% by mass and a phenol aqueous solution having a concentration of about 65% by mass. The difference in osmotic pressure between the separated two liquids is about 143 atmospheres. This value is about 5 times as high as the osmotic pressure difference between sea water having a salt concentration of about 3.5% by mass and river water having a salt concentration of about 0% by mass.

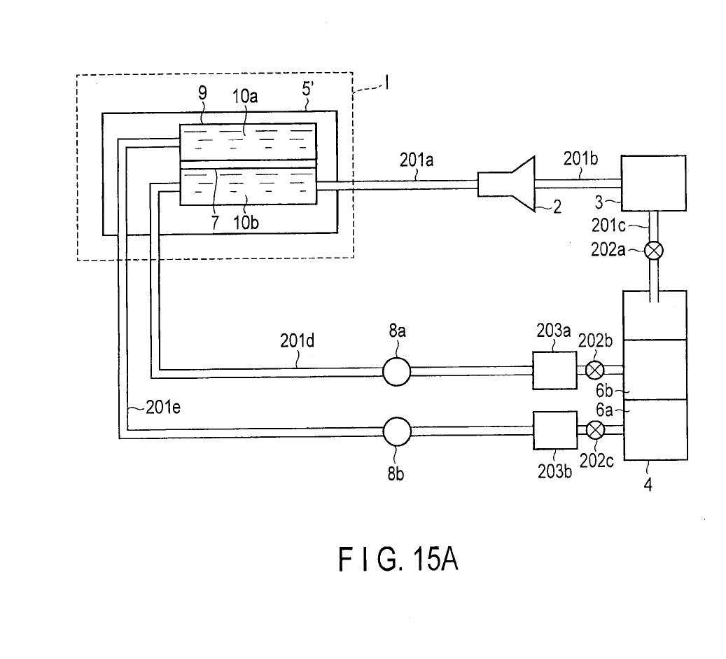

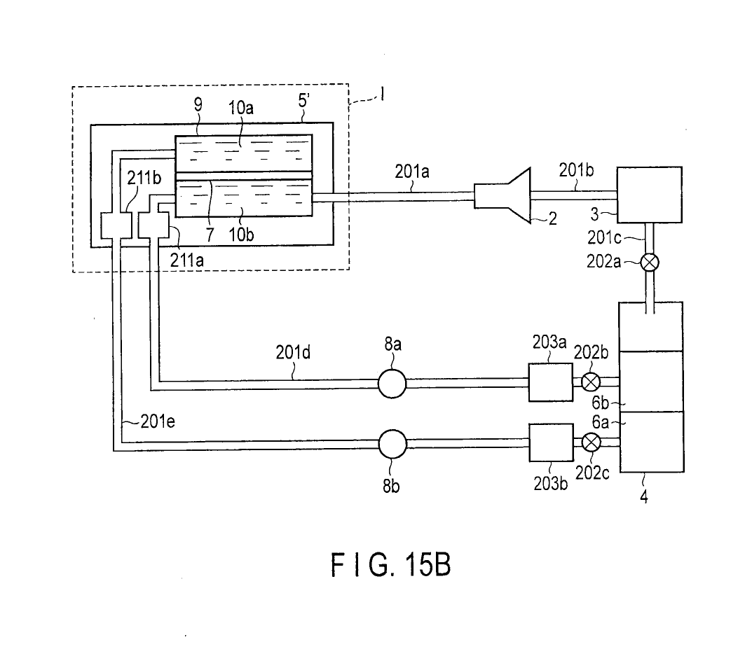

FIG. 15A is a schematic diagram showing one example of the circulatory osmotic pressure electricity generation system 200 of the second embodiment. The circulatory osmotic pressure electricity generation system 200 will now be described in further details with reference to FIG. 15A.

This circulatory osmotic pressure electricity generation system is similar in structure to that of the system 100 of the first embodiment except that the heat source 5′ is mounted not on the separating tower 4, but on the osmotic pressure generator 1. More specifically, a circulatory osmotic pressure electricity generation system 200 comprises an osmotic pressure electricity generating apparatus 200a and a working medium circulating in the osmotic pressure electricity generating apparatus 200a. The osmotic pressure electricity generating apparatus 200a comprises an osmotic pressure generator 1, a turbine 2, a buffer tank 3, a separating tower 4 and a heat source 5′. The osmotic pressure generator 1 and the turbine 2 are connected to each other via a pipeline 201a. The turbine 2 and the buffer tank 3 are connected to each other via a pipeline 201b. The tank 3 and the separating tower 4 are connected to each other via a pipeline 201c. An on-off valve 202a is interposed in pipeline 201c. The separating tower 4 and the osmotic pressure generator 1 are connected to each other via a pipeline 201d and a pipeline 201e. An on-off valve 202b, a tank 203a and a pump 8a are interposed in pipeline 201d in this order from the side of the separating tower 4. An on-off valve 202c, a tank 203b and a pump 8b are interposed in the pipeline 201e in this order from the side of the separating tower 4. The heat source 5′ is mounted on the osmotic pressure generator 1.

The electricity generation of the circulatory osmotic pressure electricity generation system 200 is carried out as follows.

A low-concentration solution 6a contained in the first chamber of the osmotic pressure generator 1 and a high-concentration solution 6b contained in the second chamber are brought into contact with each other via an osmosis membrane 7. Here, the liquid accommodated in the osmotic pressure generator 1 is maintained at a temperature higher than the upper critical temperature by the heat of the heat source 5′. The liquid water pressure generated by the difference in osmotic pressure created as the liquid moves from the first chamber to the second chamber, causes liquid to flow out from the outlet 12, which is transferred to the turbine 2 via pipeline 201a. Thus created liquid flow rotates the turbine 2, thereby generating electricity. After generating electricity by rotating the turbine 2, the liquid is transferred to the tank 3 via pipeline 101b. The tank 3 temporarily accommodates the transferred liquid. When the on-off valve 202a interposed in pipeline 201c is opened at a predetermined timing, the liquid contained in the tank 3 is transferred to the separating tower 4. In the separating tower 4, the transferred mixture liquid is subjected to phase separation. The phase separation is carried out by radiation cooling as the solution to be separated is let stand or set still. After the completion of the phase separation in the separating tower 4, the two on-off valves 202b and 202c are opened. Thus, the low-concentration solution 6a is transferred to the first chamber by the pump 8 via pipeline 201e and the inlet, whereas the high-concentration solution 6b is transferred to the second chamber by the pump 8 via pipeline 201d and the inlet.

As the above-described operation is repeated, the working medium circulates in the osmotic pressure electricity generating apparatus 200a. By the circulation of the worming medium, the osmotic pressure electricity generation system continuously generates electricity. The working medium should only be selected from those having an upper critical temperature appropriate for the environment in which the osmotic pressure electricity generation system is operated. The temperature control in the osmotic pressure electricity generation system may be determined according to the upper critical temperature of the working medium employed. In accordance with necessity, for example, in the osmotic pressure generator 1, the members other than a portion of the peripheral pipelines are placed at a temperature lower than the upper critical temperature. For example, it is preferable that such a working medium whose an upper critical temperature is higher than room temperature at all times be selected.

It should be noted here that the upper critical temperature and the lower critical temperature are not mutually exclusive concepts, but they are similar in the respect both are critical temperatures at which a two-component mixed solution transfers its phase into two phases. Further, as illustrated in the first and second embodiments, for example, aqueous solutions of nicotine and 2-butoxyethanol each have both critical points of an upper critical temperature and a lower critical temperature. Therefore, these working media are usable in the osmotic pressure electricity generating apparatus of both of the first and second embodiments.

The two-component mixed solution which has a lower critical temperature and an upper critical temperature itself, is conventionally known; however the above-described use of the solution has not been reported. By utilizing the two-component mixed solution in the electricity generation system, it is possible to provide an osmotic pressure electricity generation system more easily with a simpler structure. Further, the working medium circulating the system does not produce gas at any portion, step, or even in the separating step, and therefore it is even safer.

Incidentally, the osmotic pressure electricity generating apparatus of the second embodiment may comprise pre-heat tanks 211a and 211b as shown in FIG. 15B. The former preheat tank 211a is interposed in pipeline 201d which communicates the osmotic pressure generator 1 and the pump 8a with each other. The latter preheat tank 211b is interposed in pipeline 201e which communicates the osmotic pressure generator 1 and the pump 8b with each other. In this case, the heat source 5′ should be mounted such as to heat the preheat tanks 211a and 211b as well in addition to the osmotic pressure generator 1. With the preheat tanks 211a and 211b, the liquid to flow into the osmotic pressure generator 1 is preheated before flowing thereinto. Alternatively, in place of the preheat tanks 211a and 211b, a sufficiently long pipeline to obtain sufficient heat from the heat source 5′ may be prepared with the source 5′ mounted thereon. In this case, the pipeline may be bent several times to be appropriately arranged.

According to the second embodiment, a preheat tank or a heat exchanger is provided on the pipe which guides the working medium immediately before flowing into the osmotic pressure generator 1. In such a version that the preheat tank or heat exchanger is heated by the heat source 5′, a schematic diagram of the osmotic pressure electricity generating apparatus of the second embodiment differs from that shown in FIG. 15A by the portion indicated by broken line I. As described, when the working medium is preheated by the preheat tanks 211a and 211b or heat exchanger before flowing into the osmotic pressure generator 1, it is possible to more reliably reach a temperature which transfers a low-concentration solution and a high-concentration solution into a single-phase mixed solution.

### Third Embodiment

An osmotic pressure element may be used in the osmotic pressure generator 1 in the first or second embodiment. The osmotic pressure element is an osmotic pressure generator 1 having a volume of about 1 L to about 20 L. A plurality of such osmotic pressure elements may be aggregated into an osmotic pressure module, which is used to integrate the pressures of these osmotic pressures into one pressure to be outputted. In the osmotic pressure module, if one of the elements is degraded by wearing, it is possible to replace only the degraded one.

An example of the osmotic pressure generator 1 provided as an osmotic pressure element will now be described with reference to accompanying drawings.

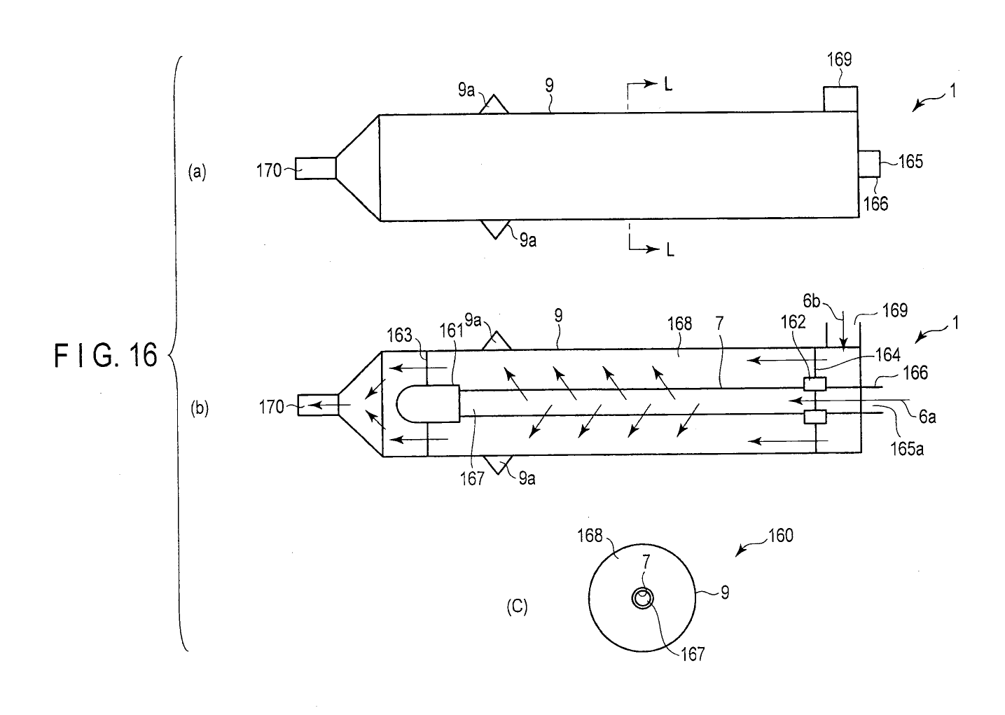

FIG. 16A is a side view of the osmotic pressure generator 1, FIG. 16B is a longitudinal section of the osmotic pressure generator 1, and FIG. 16C is a cross section taken along the line L-L.

The osmotic pressure generator 1 comprises a cylindrical sealed container 9. The cylindrical sealed container 9 comprises a sealed end (on the right side), which comprises an opening portion 165a at the center. The other end (the left side) of the sealed container 9 is formed into a tapered shape down towards a distal end, which comprises an outlet 170 for allowing the liquid to flow out.

A cylindrical osmosis membrane 7 is provided in the cylindrical sealed container 9. A first end (on the left side) of the cylindrical osmosis membrane 7, located on the tapered end side of the sealed container 9 is covered with a cap 161 to block an opening at the left end. A second end (on the right side) of the cylindrical osmosis membrane 7 is connected to a nozzle 166 extended via opening portion 165a of the cylindrical sealed container 9. The osmosis membrane 7 and the nozzle 166 are affixed to each other with a ring-shaped joint member 162 while they abut against each other. The nozzle 166 projects to the outside from the right end of the sealed container 9. The cap 161 and the joint member 162 are fixed to the inner wall surface of the sealed container 9 via support plates 163 and 164, and thus the osmosis membrane 7 is supported in the sealed container 9. As shown in FIG. 16C, the osmosis membrane 7 has a cylindrical shape. Each of the support plates 163 and 164 has a structure in which a plurality of support pieces are radially fixed between an inner ring and an outer ring, respectively, and the liquid is allowed to pass through gaps between the support pieces.

With the arrangement of the cylindrical osmosis membrane 7 in the sealed container 9 as described above, a first chamber 167 is formed inside the cylinder of the osmosis membrane 7, and a second chamber 168 situated between the osmosis membrane 7 and the sealed container 9. A low-concentration solution 6a is supplied into the first chamber 167 through the nozzle 166 projecting from the right end of the sealed container 9. Meanwhile, an inlet 169 is provided near the right end of the sealed container 9. The high-concentration solution 6b is supplied into the second chamber 168 through the inlet 169, and allowed to flow out from an outlet 170 at the left end.

The osmotic pressure is produced by the osmotic pressure generator 1 in the following manner. That is, a low-concentration solution 6a is introduced to the first chamber 167 via the nozzle 166. The high-concentration solution 6b is introduced to the second chamber 168 via the inlet 169. A portion of the low-concentration solution 6a in the first chamber 167 permeates through the osmosis membrane 7 and moves to the second chamber 168 due to osmotic pressure. As the portion of the low-concentration solution 6a moves to produce a liquid pressure, which causes the high-concentration solution 6b in the second chamber 168 to flow out from the outlet 170. Thus, utilizing the liquid pressure produced by the solution flowing from the outlet 170, electricity is generated.

The osmotic pressure generator 1 may be used while being secured to a support member such as a base, a rack, a stand or a tower. When the osmotic pressure generator 1 is secured to such a support member, the generated pressure can be operated efficiently. The osmotic pressure generator 1 may comprise a projection 9a on an outer side thereof, for the fixation. The fixation of the osmotic pressure generator 1 to the support member may be realized by holding the projection 9a in with, for example, a spring structure provided in the support member.

A further example of the osmotic pressure generator 1 provided as the osmotic pressure element will now be described with reference to drawings.

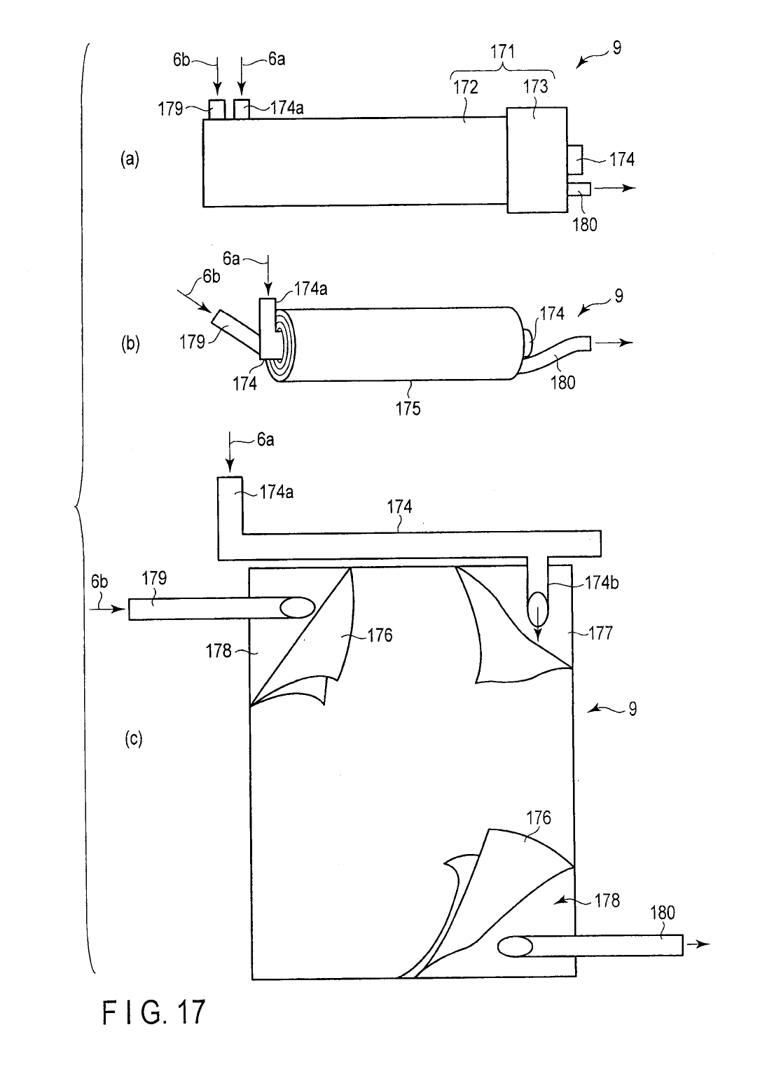

FIG. 17A is a side view of the osmotic pressure generator 1, FIG. 17B is a side view of the sealed container 9 accommodated in a housing 171, and FIG. 17C is a developed schematic view of the sealed container 9 shown in FIG. 17B.

The osmotic pressure generator 1 comprises a hollow cylindrical housing 171, and a sealed container 9 accommodated in the housing 171. The housing 171 comprises a cylindrical main body 172 with a sealed left end, and a cap 173 fit an opened right end of the cylindrical main body.

The sealed container 9 comprises a structure in which a liquid accommodation member 175 is rolled around a hollow rod member 174. The hollow rod member 174 is formed of, for example, a synthetic resin, and comprises, near the left end, a first inlet 174a configured to supply a low-concentration solution 6a, and a first outlet 174b configured to allow a low-concentration solution 6a to flow out, near the left end, all as an integral body. The first inlet 174a and the first outlet 174b are each a thin film tube formed of a synthetic resin.

The liquid accommodation member 175 comprises two flat bags formed by affixing three films together by their peripheries, and thus the second film functions as a separating membrane 176 of the two flat bags. The separating membrane 176 is a stacked film comprising an osmosis membrane and a film-like osmotic pressure inducer. The inside of the first flat bag located on the osmosis membrane side with respect to the separating membrane 176, functions as a first chamber 177. The inside of the second flat bag located on the osmotic pressure inducer side with respect to the separating membrane 176, functions as a second chamber 178.

In the structure in which the liquid accommodation member 175 is rolled on the hollow rod member 174, the first outlet 174b of the hollow rod member 174 is inserted to the first chamber 177 located on the right-end side of the first flat bag. A second inlet (second inlet tube) 179 configured to supply a high-concentration solution is inserted to the second chamber 178 located on the left-end side of the second flat bag, whereas a second outlet (second outlet tube) 180 configured to allow the high-concentration solution to flow out is inserted to the second chamber 178 located on the right-end side of the second flat bag.

The first inlet 174a of the hollow rod member 174 extends to the outside through near the left end of the housing 171. The second inlet 179 extends to the outside through near the left end of the housing 171. The second outlet tube 180 extends to the outside through the cap 173 of the housing 171.

The osmotic pressure is generated by the osmotic pressure generator 1 as follows. The low-concentration solution 6a is introduced to the first chamber 177 via the first inlet 174a, the hollow rod member 174 and the first outlet 174b, whereas the high-concentration solution 6b is introduced to the second chamber 178 via the second inlet 179. The low-concentration solution 6a in the first chamber 177 permeates through the separating membrane 176 and moves to the second chamber 178 by the osmotic pressure generated with the osmosis membrane constituting the separating membrane 176. Because of the liquid pressure produced as a portion of the low-concentration solution moves, the high-concentration solution 6b in the second chamber 178 flows out from the second outlet 180. Thus, utilizing the liquid pressure produced by the solution flowing from the second chamber 178, electricity is generated.

According to the osmotic pressure generator 1 of this embodiment, the liquid accommodation member 175 comprises the first and second flat bags with the separating membrane 176 interposed therebetween, and thus the insides of the first and second flat bags are utilized as the first chamber 177 and the second chamber 178. With this structure, the area of the osmosis membrane which constitutes the separating membrane 176 can be increased with compact dimensions, thereby making it possible to further raise the liquid pressure of the solution flowing out from the second outlet 180.

### Fourth Embodiment

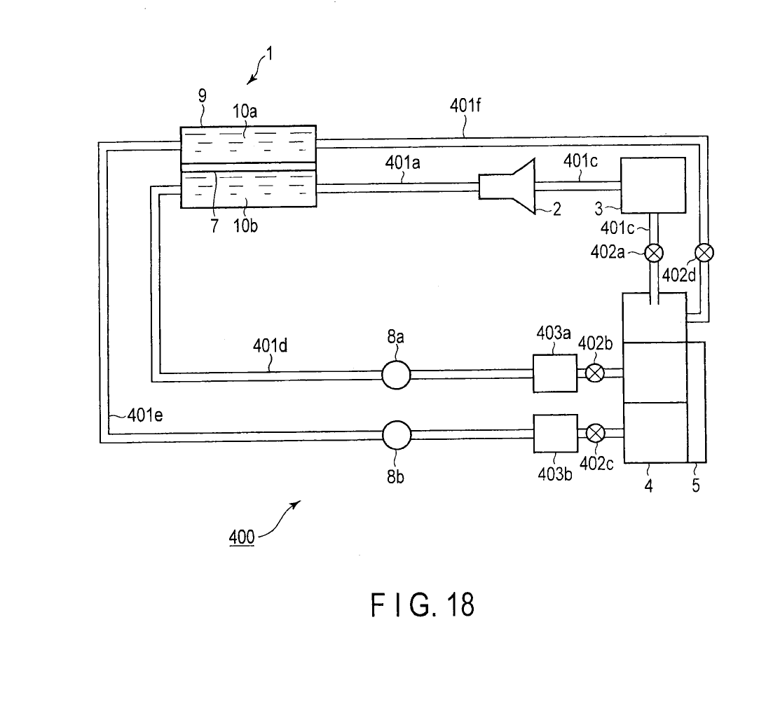

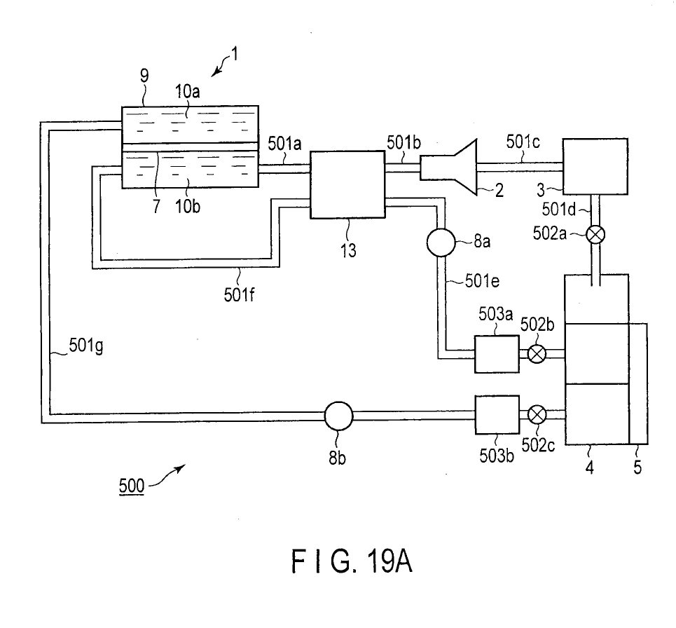

In the circular osmotic pressure electricity generation system described in the first or second embodiment, the osmotic pressure generator 1 and the separating tower 4 may be connected to each other further by a pipeline 401f. An example of such a system is shown in FIG. 18.

In a circular osmotic pressure electricity generation system 400, a container 9 of the osmotic pressure generator 1 is provided an outlet at a location of the first chamber 10a in the container 9. An inlet is further provided the separating tower 4. The outlet of the first chamber 10a and the inlet of the separating tower 4 are communicated with each other via a pipeline 401f. With this structure, a remainder portion of the low-concentration solution 6a, which did not move to the second chamber 10b from the first chamber 10a, flows out of the outlet of the first chamber 10a. In this way, it is possible to prevent the solute which did not permeate the osmosis membrane 7 and move to the second chamber 10b, from accumulating in the first chamber 10a. Consequently, the increase in concentration of the solution accommodated in the first chamber 10a can be prevented. Thus, with the outlet provided in the container located in the first chamber 10a, it is possible to prevent the lowering of the osmotic pressure difference between the liquid contained in the side of the first chamber 10a with respect to the osmosis membrane 7 and the liquid contained in the side of the second chamber 10b. Further, possible damages on the osmosis membrane 7 can be prevented, which may be caused by a precipitating portion of the solute which can no longer be dissolved into the solution. In this case, an on-off valve 402d is interposed in pipeline 401f. It is preferable that the portion of the liquid which flows out from the outlet of the first chamber 10a be allowed to flow into the separating tower 4 via pipeline 401f by opening the on-off valve 402d. This operation will be explained later.

Alternatively, the circular osmotic pressure electricity generation system 400 may have such a structure that a tank and an on-off valve are interposed in the pipeline 401f in this order from the side of the first chamber 10a. In the tank, the liquid portion from the first chamber 10a may be temporarily reserved depending on the operation state of the separating tower 4.

Note that FIG. 18 illustrates an example of an osmotic pressure electricity generation system which circulates a working medium having a lower critical temperature. But this embodiment is applicable as well to such an osmotic pressure electricity generation system which circulates a working medium having an upper critical temperature. In this case, it suffices if the heat source 5 is mounted not on the separating tower 4, but on the osmotic pressure generator 1.

### Fifth Embodiment

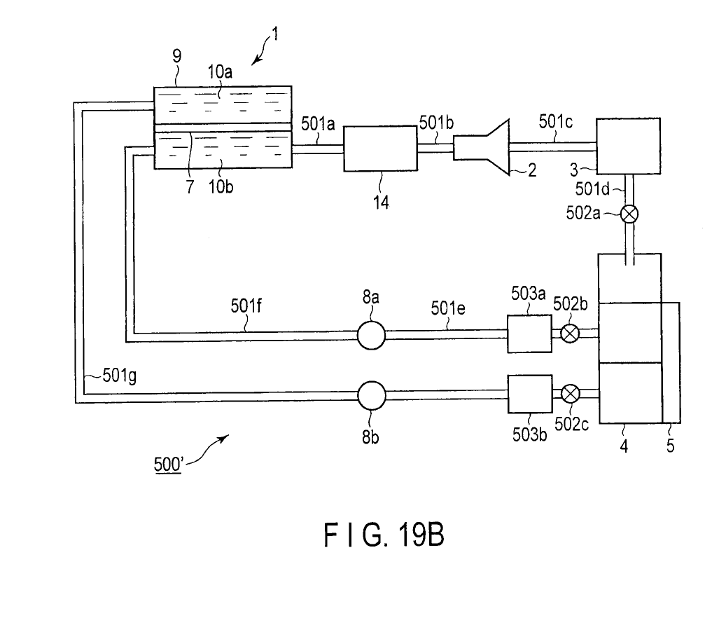

The circular osmotic pressure electricity generation system described in the first or second embodiment may further comprise a pressure exchanger or a pumping-up device. FIG. 19A shows a modified example of the circular osmotic pressure electricity generation system 100 of the first embodiment, which further comprises a pressure exchanger 13. The pressure exchanger 13 is interposed and bridged over between a pipeline 501a and a pipeline 501f in order to adjust the liquid pressure therebetween. The flux of the solution which rotates the turbine 2 thus depend not only on the osmotic pressure difference between the liquid in the first chamber 10a and that of the second chamber 10b, but also on the difference in liquid pressure between the low-pressure solution 6a flowing in from the first inlet 11a and the high-pressure solution 6b flowing in from the second inlet 11b. The electric energy obtained by electricity generation can be maximized by adjusting the difference in liquid pressure between the low-pressure solution 6a and the high-pressure solution 6b using the pressure exchanger 13.

Alternatively, FIG. 19B shows a modified example of the circular osmotic pressure electricity generation system 100 of the first embodiment, which further comprises a pumping-up device 14. The pumping-up device 14 is provided between the osmotic pressure generator 1 and the turbine 2 via pipes 501a and 501b. With the pumping-up device 14 installed in the osmotic pressure electricity generating apparatus 100a, the working medium can be circulated more easily. Therefore, the electricity generation by the turbine 2 can be more reliably carried out. The pumping-up device 14 moves and accommodates the liquid from the osmotic pressure generator 1 to a level higher than the positions where the osmotic pressure generator 1 and the turbine 2 are situated. Then, the liquid is dropped towards the turbine 2 from the high level at a predetermined flow, and thus the turbine 2 is rotated by the descending flux.

### Sixth Embodiment

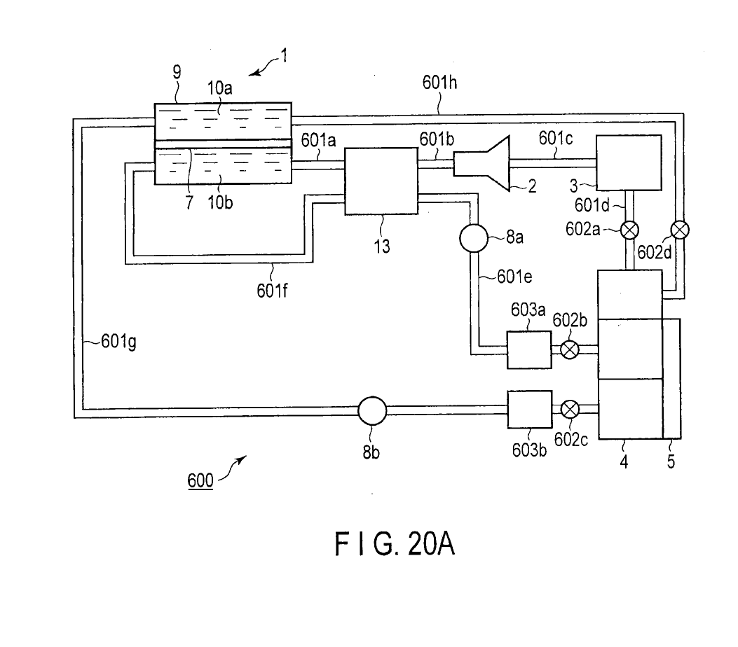

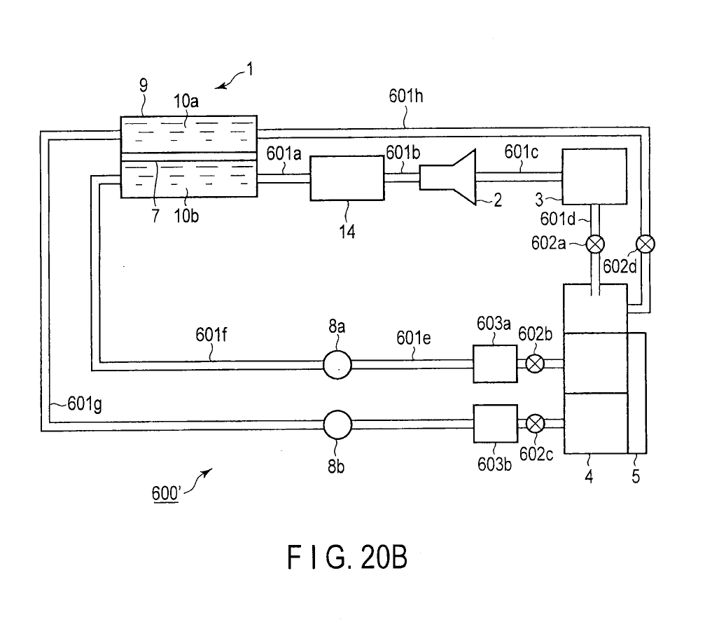

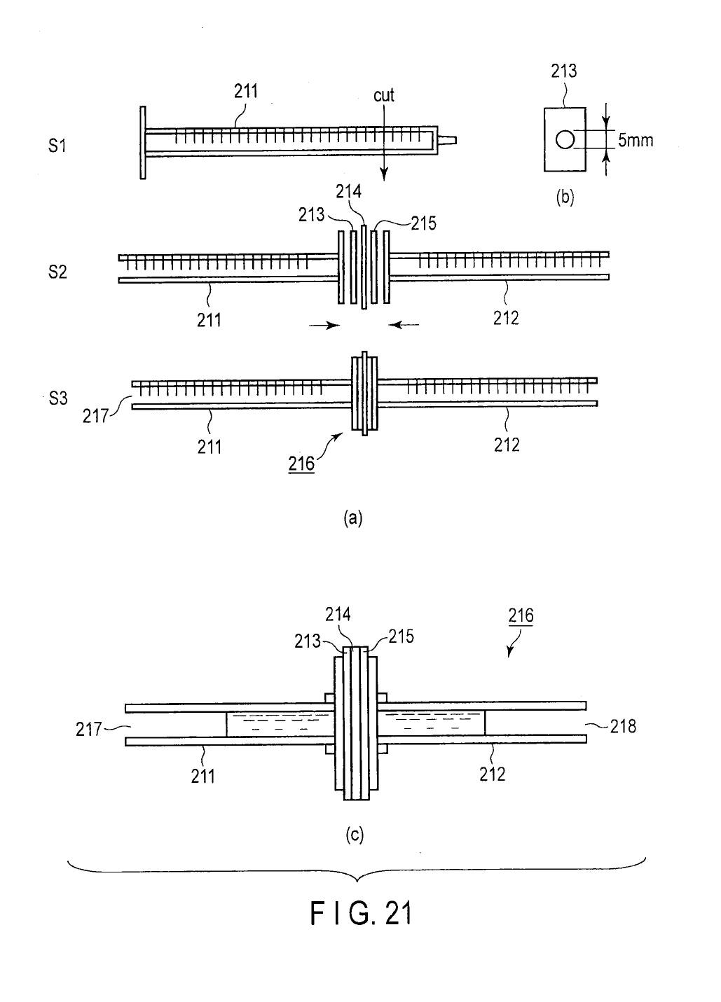

The circular osmotic pressure electricity generation system 400 described in the fourth embodiment may further comprise a pressure exchanger 13 or a pumping-up device 14. FIGS. 20A and 20B show an example of such a circular osmotic pressure electricity generation system 600. The circular osmotic pressure electricity generation system 600 comprises a pipeline 601h which connects the outlet of the container 9 located in the first chamber 10a of the osmotic pressure generator 1, and the separating tower 4 to each other. The pressure exchanger 13 is configured to adjust the liquid pressure between a pipeline 601a and a pipeline 601f. With this structure, the electric energy obtained by electricity generation can be maximized. As shown in FIG. 20, the pumping-up device 14 enables the working medium to circulate more easily. Therefore, the electricity generation by the turbine can be more reliably carried out.

### EXAMPLES

### Syringe Test Device

A manufacturing process of a syringe test device will now be described with reference to FIG. 21A.

First, two 1 ml-disposable resin syringes 211 and 212 for tuberculin were prepared. In each of the resin syringes 211 and 212, a distal end to which an injection needle is to be set was cut out. (S1) The grip portions of the two cut syringes 211 and 212 were set to face each other, and two rubber pieces and one osmosis membrane were interposed therebetween. More specifically, they were interposed in the order of the first syringe 211, the first rubber piece 213, the osmosis membrane 214, the second rubber piece 215 and the second syringe 212, and they are fixed together with a clip (not shown). (S2)

As described above, a syringe test device 216 was obtained. (S3) As the osmosis membrane 214, ES 20, which is an RO membrane manufactured by Nitto Denko Corporation, was used. As the first and second rubber pieces 213 and 215, rubber disks were used, with a circular hole having a diameter of 5 mm opened therein as shown in FIG. 21B.

### (2) Syringe Test 1

### Example 1

As shown in FIG. 21C, 0.5 ml of pure water was injected to the first syringe 211 of the syringe test device 216 manufactured in item (1) above, through an opening 217 thereof, whereas 0.5 ml of 100% by mass of 2-butoxyethanol was injected to the second syringe 212 through an opening 218 thereof. The injection of the liquids to the first syringe 211 and the second syringe 212, respectively, was carried out until the liquids contact the osmosis membrane 214. Then, the first syringe 211 and the second syringe 212 were placed horizontally with respect to the installation surface, and let stand for 7 hours at 25° C. Here, the migration of water from the first syringe 211 to the second syringe 212 was observed during the 7-hour period.

### Example 2

A syringe test was carried out in a similar manner to Example 1 except that 3.5% by mass of salt water was injected in place of 2-butoxyethanol to the second syringe 212.

Results

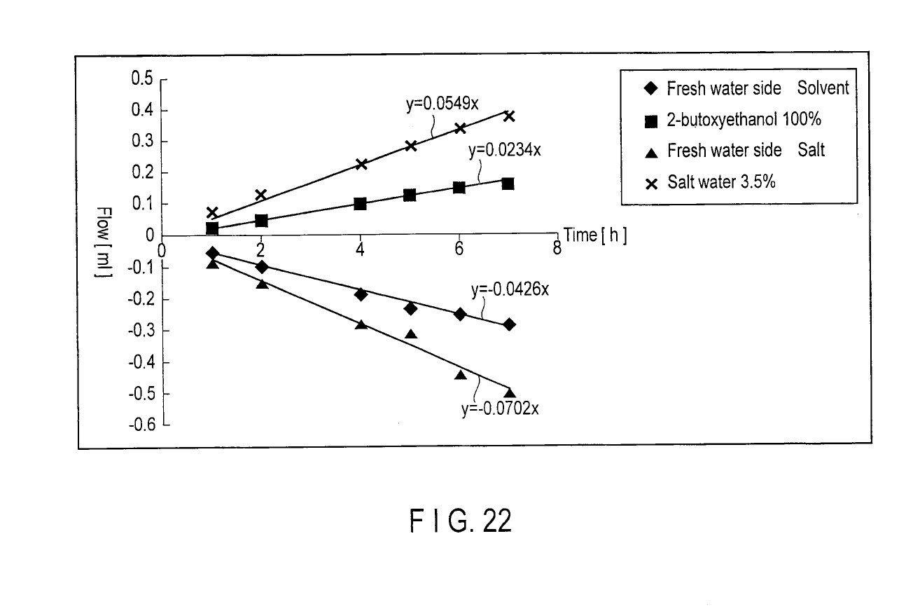

The results of the tests of Examples 1 and 2 are shown in FIG. 22. FIG. 22 indicates the flow of water migration along with time. The vertical axis represents the flow in milliliters (ml) as unit, whereas the horizontal axis represents time in hours (h). As is clear from FIG. 22, when salt water was used, a more amount of water was moved as compared to the case of 2-butoxyethanol. This is considered to be because 2-butoxyethanol more abruptly drew water than salt water. More specifically, water permeates the osmosis membrane and enters the other side very quickly such that concentration polarization is created in proximity to the membrane on the second syringe side, thus forming a water layer. Therefore, the results of Examples 1 and 2 demonstrated a potential advantageous effect of 2-butoxyethanol.

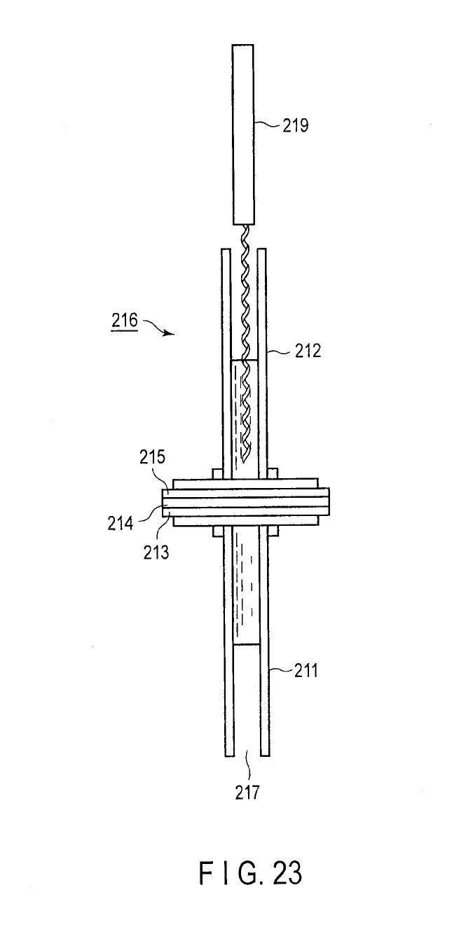

In order to eliminate the influence of such concentration polarization, the position of the syringe test device was changed as described in the following example, and further tests were conducted with an addition operation that the inside of the second syringe was stirred with a pencil mixer 219. The pencil mixer employed was “AS ONE Pencil Mixer DX manufactured by As One Corporation”. FIG. 23 illustrates a syringe test device 216 placed vertically.

### (3) Syringe Test 2

### Example 3

A syringe test device was prepared in a similar manner to Example 1 except that 1.2% by mass of salt water was injected to the first syringe and an ammonium carbonate solution having a solubility limit at room temperature, that is, 4 mol/l, was injected to the second syringe. The syringe test device was secured such that the first and second syringes were arranged vertically with respect to the surface on which they are placed, with the second syringe 212 located in an upper section. Subsequently, they were let stand for 5 minutes at 25° C. while the inside of the second syringe was stirred with the pencil mixer 219. Here, the migration of water from the first syringe to the second syringe was observed during the 5-minute period.

### Example 4

A syringe test was carried out in a similar manner to Example 3 except that the stirring with the pencil mixer 219 was not conducted and the migration of water was observed.

### Example 5

A syringe test was carried out in a similar manner to Example 3 except that ethanol having a concentration of 100% by mass was injected in place of 2-butoxyethanol to the second syringe, and the migration of water was observed.

### Example 6

A syringe test was carried out in a similar manner to Example 5 except that the stirring with the pencil mixer 219 was not conducted and the migration of water was observed.

### Example 7

A syringe test was carried out in a similar manner to Example 3 except that 3.5% by mass of salt water was injected in place of ethanol to the second syringe and the migration of water was observed.

### Example 8

A syringe test was carried out in a similar manner to Example 7 except that the stirring with the pencil mixer 219 was not conducted and the migration of water was observed.

### Example 9

A syringe test was carried out in a similar manner to Example 8 except that an ammonium carbonate solution was injected in place of 3.5% by mass of salt water to the second syringe and 1.2% by mass of salt water was injected in place of pure water to the first syringe, and further, the syringe test device was let stand at 40° C. Thus, the migration of water was observed.

### Example 10

A syringe test was carried out in a similar manner to Example 4 except that 2-butoxyethanol having a concentration of 50% by mass was injected to the second syringe, and further, the syringe test device was let stand at 20° C. Thus, the migration of water was observed.

### Example 11

A syringe test was carried out in a similar manner to Example 3 except that 2-butoxyethanol having a concentration of 50% by mass was injected to the second syringe, and further, the syringe test device was let stand at 20° C. Thus, the migration of water was observed.

Results

The results of Examples 3 to 11 are shown in Table 3 below.

TABLE 3

| | Solvent 1 | Solvent 2 | |
|---|---|---|---|
| | (First | (Second | Experimental |
| | syringe) | syringe) | conditions |
| Example 3 | 1.2% by mass | Ammonium | Set Still |
| | of salt water | carbonate | |
| Example 4 | Pure water | 3.5% by mass | Set Still |
| | | of salt water | |
| Example 5 | Pure water | 100% by mass | Set Still |
| | | of ethanol | |
| Example 6 | Pure water | 100% by mass | Stirred |
| | | of ethanol | |
| Example 7 | Pure water | 100% by mass of | Set Still |
| | | 2-butoxyethanol | |
| Example 8 | Pure water | 100% by mass of | Stirred |
| | | 2-butoxyethanol | |
| Example 9 | 1.2% by mass | Ammonium | Set Still |
| | Of salt water | carbonate | |
| Example 10 | Pure water | 50% by mass | Stirred |
| | | of 2-butoxyethanol | |
| Example 11 | 1.2% by mass | 50% by mass of | Stirred |
| | of salt water | 2-butoxyethanol | |

| | Flow | Temp. | Osmosis | |
|---|---|---|---|---|
| | (m/h) | (° C.) | membrane | Remarks |
| Example 3 | 0.0015 | 40 | ES20 | |
| Example 4 | 0.0034 | 25 | ES20 | |
| Example 5 | 0.0015 | 25 | ES20 | |
| Example 6 | 0.0061 | 25 | ES20 | Advantageous effect |
| | | | | obtained by stirring |
| Example 7 | 0.0018 | 25 | ES20 | |
| Example 8 | 0.0061 | 25 | ES20 | Advantageous effect |
| | | | | obtained by stirring |
| Example 9 | 0.0011 | 20 | ES20 | |
| Example 10 | 0.012 | 20 | ES20 | Flow in first 5 minutes |
| | | | | from start of stirring |
| Example 11 | 0.0031 | 20 | ES20 | Flow after 5 minutes from |
| | | | | start of stirring |

In Table 3 above, the unit (m/h) of the flow is indicated in unit of flux per hour and per area. That is, the unit (m/h) of the flow is a value obtained by dividing the amount (m³) of liquid moved by the membrane area (m²) and time (hour).

In Examples 6, 8 and 10, the flux was calculated from the amount of flow after 5 minutes of stirring. The results of Example 10 include an average flow amount from the start of stirring to 5 minutes thereafter, in which the fluxes were obtained in a similar manner. The results of Example 11 include an average flow amount from 5 minutes after the start of stirring, in which the fluxes were obtained in a similar manner.

As is clear from comparison between Examples 3 and 4, or Examples 5 and 6, the flow amount of water was increased with the stirring with the pencil mixer 219. On the other hand, as can be seen from the results of Examples 7 and 8, the effect of the stirring was not observed in the case of salt water having a concentration of 3.5% by mass. These results suggest that the difference in relative density between the water portion, which is permeated the osmosis membrane and moved, and the liquid accommodated in the syringe to which the water portion entered, causes an influence on the concentration polarization, which acts to decrease the osmotic pressure difference. Here, the relative density of the salt water was higher than that of water, specifically, 1.02. On the other hand, the relative densities of the 2-butoxyethanol and ethanol solutions were both lower than that of water, specifically, 0.9 and 0.78, respectively. In the syringe test 2, the syringe test device was secured such that the first and second syringe were arranged vertically with respect to the surface on which they are placed, with the second syringe 212 located in an upper section. Because of the osmotic pressure difference, water permeates the osmosis membrane from the first syringe side, located in a lower side, and moves to the second syringe side in an upper side. 2-butoxyethanol and ethanol are both soluble with water. However, the liquid accommodated in the second syringe has a relative density lower than that of water, as in the case of 2-butoxyethanol or ethanol, and therefore it is considered that a layer of migrating water was formed near the osmosis membrane with the passage of time. As is clear from the results indicated in Table 3, the concentration polarization created in the second syringe by the two types of liquids was solved by the stirring.

In the circulatory osmotic pressure electricity generation system according to the embodiment, the second chamber of the osmotic pressure generator comprises the inlet and outlet. It is possible with this structure to make the liquid in the second chamber flow at all times. This structure can achieve the same stirring effect as that described previously in the second chamber. The mechanism of this embodiment is called cross-flow. With the cross-flow, it is possible to create a liquid flow by the osmotic pressure difference efficiently and continuously.

The liquids used in the above-described syringe tests each are one of the components which constitute a two-component mixed solution. Therefore, it has been suggested that osmotic pressure electricity generation can be achieved with use of a two-component mixed solution. Further, the results of the syringe test 1 have suggested possibilities that abrupt water migration can be achieved by using the above-listed liquids.

Moreover, the two kinds of components contained in a two-component mixed solution having a lower or upper critical temperature according to each embodiment are both liquids. Here, the separation of a two-component mixed solution into the two kinds of components is very much easier than the separation of a two-component mixed solution comprising solid matter and liquid, or a two-component mixed solution comprising gas and liquid, and also the separation efficiency is better.

As described above, it is now clearly possible to provide a circulatory osmotic pressure electricity generation system configured to generate electricity by circulating, as a working medium, a two-component mixed solution having a lower or upper critical temperature, at a low driving cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. As these embodiments and their modifications would fall within the spirit or scope of the inventions and are covered in the inventions described in the appended claims and their equivalents.

What is claimed is:

1. A circulatory osmotic pressure electricity generation system configured to generate electricity by using a working medium, which comprises an osmotic pressure generator, a turbine, a tank, a separating tower, a heat source and the working medium,
wherein the working medium has a critical temperature which separates a first temperature zone and a second temperature zone from each other and has a phase transition to a first phase or a second phase which occurs at the critical temperature: a) in the first temperature zone, a first liquid and a second liquid are dissolved in a liquid-liquid mutual dissolution state to form a two-component mixed solution; and b) in the second temperature zone, the first liquid and the second liquid are in a phase separation state,
the osmotic pressure generator is placed under a temperature of the working medium within the first temperature zone, and comprises:
(i) a container;
(ii) an osmosis membrane configured to compartmentalize an inside of the container into a first chamber and a second chamber;
(iii) a first inlet provided in a section of the container which is located the first chamber, and configured to allow the first liquid to flow therein;
(iv) a second inlet provided in a section of the container which is located the second chamber, and configured to allow the second liquid to flow therein; and
(v) an outlet provided in a section of the container which is located the second chamber, and configured to allow the two-component mixed solution to flow out therethrough, the two-component mixed solution being obtained from the second liquid and a portion of the first liquid dissolving each other in a liquid-liquid mutual dissolution manner in the second chamber, the portion of the first liquid being liquid which permeates through the osmosis membrane from the first chamber to the second chamber,
the turbine is configured to generate electricity by flow of the two-component mixed solution flowing out through the outlet from the second chamber of the osmotic pressure generator,
the tank is configured to accommodate the two-component mixed solution used to drive the turbine,
the heat source is mounted one of the separating tower and the osmotic pressure generator, and configured to heat liquid contained in the separating tower or the osmotic pressure generator to a temperature higher than the critical temperature, and
the separating tower is configured to separate the two-component mixed solution flowing out from the tank at a temperature in the second temperature zone into the first liquid to be returned to the first chamber and the second liquid to be returned to the second chamber.

2. The system of claim 1, wherein the osmotic pressure generator further comprises a second outlet provided in a section of the container which is located the first chamber, the second outlet being configured to allow the liquid accommodated in the first chamber to flow out therefrom.

3. The system of claim 1, wherein the heat source is water heated with exhaust heat of a factory.

4. The system of claim 1, wherein the heat source is water heated with solar heat.

5. A circulatory osmotic pressure electricity generation system configured to generate electricity by using a working medium, which comprises an osmotic pressure generator, a turbine, a tank, a separating tower, a heat source and the working medium,
wherein the working medium has a lower critical temperature and has a phase transition which occurs at the lower critical temperature: a) at a temperature lower than the lower critical temperature, a first liquid and a second liquid are dissolved in a liquid-liquid mutual dissolution state to form a two-component mixed solution; and b) at a temperature higher than the lower critical temperature, the first liquid and the second liquid are in a phase separation state,
the osmotic pressure generator is placed under a temperature lower than the lower critical temperature of the working medium, and comprises:
(i) a container;
(ii) an osmosis membrane configured to compartmentalize an inside of the container into a first chamber and a second chamber;
(iii) a first inlet provided in a section of the container which is located the first chamber, and configured to allow the first liquid to flow therein;
(iv) a second inlet provided in a section of the container which is located the second chamber, and configured to allow the second liquid to flow therein; and
(v) an outlet provided in a section of the container which is located the second chamber, and configured to allow the two-component mixed solution to flow out therethrough, the two-component mixed solution being obtained from the second liquid and a portion of the first liquid dissolving each other in a liquid-liquid mutual dissolution manner in the second chamber, the portion of the first liquid being liquid which permeates through the osmosis membrane from the first chamber to the second chamber,
the turbine is configured to generate electricity by flow of the two-component mixed solution flowing out through the outlet from the second chamber of the osmotic pressure generator,
the tank is configured to accommodate the two-component mixed solution used to drive the turbine,
the heat source is mounted the separating tower and configured to heat liquid accommodated in the separating tower to a temperature higher than the lower critical temperature, and
the separating tower is configured to separate the two-component mixed solution flowing out from the tank into the first liquid to be returned to the first chamber and the second liquid to be returned to the second chamber by heating the two-component mixed solution to a temperature higher than the lower critical temperature.

6. The system of claim 5, wherein the osmotic pressure generator further comprises a second outlet provided in a section of the container which is located the first chamber, the second outlet being configured to allow the liquid accommodated in the first chamber to flow out therefrom.

7. The system of claim 5, wherein the lower critical temperature is higher than a solidification point of each of the first liquid and the second liquid.

8. The system of claim 5, wherein the heat source is water heated with exhaust heat of a factory.

9. The system of claim 5, wherein the heat source is water heated with solar heat.

10. A circulatory osmotic pressure electricity generation system configured to generate electricity by using a working medium, which comprises an osmotic pressure generator, a turbine, a tank, a separating tower, a heat source and the working medium,
wherein the working medium has an upper critical temperature and has a phase transition which occurs at the upper critical temperature: a) at a temperature higher than the upper critical temperature, a first liquid and a second liquid are dissolved in a liquid-liquid mutual dissolution state to form a two-component mixed solution; and b) at a temperature lower than the upper critical temperature, the first liquid and the second liquid are in a phase separation state,
the osmotic pressure generator is placed under a temperature higher than the upper critical temperature of the working medium, and comprises:
(i) a container;
(ii) an osmosis membrane configured to compartmentalize an inside of the container into a first chamber and a second chamber;
(iii) a first inlet provided in a section of the container which is located the first chamber, and configured to allow the first liquid to flow therein;
(iv) a second inlet provided in a section of the container which is located the second chamber, and configured to allow the second liquid to flow therein; and
(v) an outlet provided in a section of the container which is located the second chamber, and configured to allow the two-component mixed solution to flow out therethrough, the two-component mixed solution being obtained from the second liquid and a portion of the first liquid dissolving each other in a liquid-liquid mutual dissolution manner in the second chamber, the portion of the first liquid being liquid which permeates through the osmosis membrane from the first chamber to the second chamber,
the heat source is mounted on the osmotic pressure generator and configured to heat liquid contained in the osmotic pressure generator to a temperature higher than the upper critical temperature,
the turbine is configured to generate electricity by flow of the two-component mixed solution flowing out through the outlet from the second chamber of the osmotic pressure generator;
the tank is configured to accommodate the two-component mixed solution used to drive the turbine, and
the separating tower is configured to separate the two-component mixed solution flowing out from the tank into the first liquid to be returned to the first chamber and the second liquid to be returned to the second chamber by placing the two-component mixed solution flowing out from the tank at a temperature lower than the upper critical temperature.

11. The system of claim 10, wherein the osmotic pressure generator further comprises a second outlet provided in a section of the container, where the first chamber is located, and configured to allow the liquid accommodated in the first chamber to flow out therefrom.

12. The system of claim 10, wherein the heat source is water heated with exhaust heat of a factory.

13. The system of claim 10, wherein the heat source is water heated with solar heat.
